(19) United States
(12) Patent Application Publication
(10) Pub. No.: US 2024/0246277 A1
(43) Pub. Date: Jul. 25, 2024

(54) CHARGING SYSTEM FOR FEEDING PROCESSING MATERIAL TO AN EXTRUDER SCREW, HAVING AXIALLY EXTENDING RECESSES IN A HOPPER WALL

(71) Applicant: AIM3D GMBH, Rostock (DE)

(72) Inventors: René Zielke, Rostock (DE); Tim Weidner, Rostock (DE); Vincent Morrison, Krakow am See (DE); Clemens Lieberwirth, Rostock (DE)

(21) Appl. No.: 18/577,552

(22) PCT Filed: Jun. 30, 2022
(86) PCT No.: PCT/EP2022/068074

§ 371 Date: Jan. 8, 2024

(30) Foreign Application Priority Data
Jul. 14, 2021 (DE) 10 2021 207 518.5

(51) Int. Cl. B29C 48/285; B29C 31/02; B29C 64/329; B29K 105/00; B33Y 30/00

(52) U.S. Cl. CPC B29C 48/288; B29C 31/02; B29C 64/329; B33Y 30/00; B29C 48/2886; B29K 2105/251

(57) ABSTRACT

It is provided a charging system for feeding processing material, in particular granular processing material to at least one extruder screw, comprising a hopper that is adapted to guide the processing material along a feed direction to the extruder screw and extends along a hopper axis, which in the properly mounted state of the charging system extends parallel to a longitudinal axis of the extruder screw.

In the proposed charging system, the hopper includes a plurality of recesses each extending axially with respect to the hopper axis on a hopper wall extending around the hopper axis.

### CROSS-REFERENCE TO A RELATED APPLICATION

This application is a National Phase Patent Application of International Patent Application Number PCT/EP2022/068074, filed on Jun. 30, 2022, which claims priority of German Patent Application Number 10 2021 207 518.5, filed on Jul. 14, 2021.

### TECHNICAL FIELD

The proposed solution relates in particular to a charging system for feeding processing material to an extruder screw, in particular an extruder screw for additive manufacturing with metal, ceramic and/or plastic injection molding granulates.

### BACKGROUND

Screw extruders above all are used in the series production of components by means of injection molding and die casting. The extruder screw, injection nozzle and die mostly are disposed in a horizontal line relative to each other. The filling with material, which chiefly is present as granulate or powder, in general is effected in the rearmost part of the screw extruder, in the so-called feed zone. Via a hopper that sits on a barrel section of the extruder the material is directly vertically guided onto the extruder screw. Due to a sufficiently large cross-section in the hopper, which prevents bridging, the material falls onto the screw driven by gravity and is drawn in by the same. In series production, so-called three-zone screw extruders are used in general, by which the material is drawn in and conveyed to the nozzle. The material is compressed, deaerated and homogenized. Thereafter, a pressure is built up for filling the die.

The feed zone of the screw extruder frequently is configured as a barrel section in a housing of the screw extruder. On this barrel section a hopper is arranged, via which the material can be supplied to the screw. In terms of their minimum cross-section, barrel section and hopper are to be chosen such that there can be no bridging of the material present in the form of granules. This greatly depends on the angle of repose and the coefficient of friction of the bulk material used.

DE 10 2014 018 081 A1 describes a 3D printing device for the additive manufacture of metallic components. There is likewise used a screw extruder that processes processing material present in the form of granules. In a traversable printing head of the 3D printing device, the thermoplastically deformable processing material is extruded layer by layer by means of a perpendicularly arranged screw extruder, in order to produce a three-dimensional component. More details concerning the conveyance of the processing material to the extruder screw are not contained in DE 10 2014 018 081 A1.

The use of screw extruders for additive manufacturing is limited above all by their weight and their overall size, which typically greatly depend on the length of the extruder screw, as the screw extruders either must be of traversable design or the entire working field is moved. The latter variant, however, requires to make the entire 3D printing device distinctly oversize.

### SUMMARY

Against this background, a device and a method for extruding processing material are known already from DE 10 2017 114 841 A1, by which a compression of granular processing material can be increased in order to be able to extrude a dense and continuous strand of material. For this purpose, a comminution tool is provided in a hopper of a charging system. By means of this comminution tool, the processing material is selectively comminuted by action of the rotating extruder screw, whereby in particular a bulk density can be increased in the region of the extruder screw.

Although distinct improvements can be achieved already in the extrusion of processing material for the additive manufacture of components with the solution proposed in DE 10 2017 114 841 A1, there still is a need for improvements in this area, in particular with regard to the particular requirements in additive manufacturing processes.

Against this background, there is proposed a charging system for feeding processing material to at least one extruder screw that comprises a specially designed hopper. The hopper is adapted to conduct the processing material along a feed direction to the extruder screw. For this purpose, the hopper extends along a hopper axis, which in the properly mounted state of the charging system extends parallel to a longitudinal axis of the extruder screw. On a hopper wall extending around the hopper axis, the proposed hopper includes a plurality of recesses each extending axially with respect to the hopper axis.

In the state of the charging system mounted to an extruder apparatus for the additive manufacture of a component, the hopper axis of the proposed charging system thus extends parallel to a typically vertically extending longitudinal axis of the extruder screw. The hopper wall of the hopper then includes a plurality of axially extending recesses and hence cavities. Consequently, the recesses spring back radially towards the outside and hence represent a local increase of a hopper opening of the hopper. It was found that with a hopper of such shape significant improvements can be achieved in the extrusion of processing material, in particular of granular processing material in connection with an additive manufacturing process. For example, by using a proposed charging system more uniform extrusion patterns can be achieved with plastic granules and here in particular with comparatively tough thermoplastic materials.

In principle, the hopper can be configured as a separately manufactured, one-piece component, which can exchangeably be used on an extruder apparatus comprising at least one extruder screw. In particular, the hopper can be configured as part of a replaceable feeder that can be mounted to an extruder apparatus as a prefabricated part for the additive manufacture.

In one design variant, the recesses on the hopper wall are arranged in succession along a circumferential line around the hopper axis. The recesses in particular can be arranged uniformly distributed on the hopper wall, in particular uniformly distributed along a circular circumferential line.

The cross-sectional geometry of the recesses is variable in principle. In one design variant, the recesses are of radially outwardly curved design in a cross-section (transversely to the hopper axis), with respect to the hopper axis. This in particular includes a design of the recesses on the hopper wall concave in cross-section.

To support the conveyance of the processing material both in an axial direction along the hopper axis and hence along the longitudinal axis of the extruder screw as well as radially in the direction of the extruder screw, at least one of the recesses can be of radially tapering design. In this way, in at least one end portion, but possibly also as seen along the entire longitudinal extension of the respective recess, a radial depth of the recess decreases, in particular continuously, with increasing axial extension along the hopper axis. Thus, less space is available for the processing material along the hopper axis via the respective recess. For example, when the individual recesses are dimensioned in such a way that a width of a recess, as measured along a circumferential line around the hopper axis, corresponds at least to a maximum width or a maximum diameter of a granule of the granular processing material, granules can get into the recesses at an (upper) end of the hopper and are then, by action of the rotating extruder screw, forced to be axially displaced downwards along the recesses. The width and depth of a recess thus are adjusted e.g. to granules of a granular processing material in such a way that conveying chambers are formed on the extruder apparatus in the hopper, which each are radially bordered on the outside by a recess and radially on the inside by the extruder screw, and in operation of the extruder apparatus the individual granules are retained in these conveying chambers—adjusted to the (mean) dimensions of the granules—and are blocked against a displacement out of these conveying chambers. A width of a recess exceeds a maximum width or a maximum diameter of a granule by not more than 20%.

A recess provided on the hopper wall can be configured for receiving a granular processing material whose maximum outer dimension does not exceed 15 mm. Thus, a granule of the processing material has no outer dimension (width, length, height or diameter) that is greater than 15 mm, and a recess is dimensioned such that at an upper hopper end it has a width and radial depth that lies in the order of the maximum dimension of the granule to be processed. Design variants of the proposed solution were found to be advantageous in particular for processing granular processing material, in which all granules can be circumscribed by a spherical reference volume with a reference diameter of 15 mm or by a circular cylindrical reference volume with a reference height of 15 mm and a reference diameter of 10 mm, i.e. lie completely within a corresponding reference volume. For example, the proposed solution is advantageous for processing plastic granulates with a reference diameter of 1.5 to 6 mm, in particular of 3 mm, long-fiber granulates with a reference height up to 15 mm, in particular of 9 to 12 mm, or ceramic granulates with a reference diameter of 1.5 to 8 mm, in particular of 3 mm or 5 mm, in order to obtain a (more) uniform extrusion pattern. Consequently, the width and depth of a recess then each lie in the range of 1.875 to 18.75 mm.

To further support uniform feeding of processing material and uniform extrusion, all recesses of the hopper wall in one design variant are each formed to be radially tapering. Via a radial taper of all recesses on the hopper wall, the hopper wall can be circumferentially smooth for example at one end of the hopper, i.e. in the manner of a smooth tube portion.

Alternatively or additionally, at least one of the recesses can be formed to be axially tapering. In the case of an axial taper of a recess, a width of the recess measured in a circumferential direction in at least one end portion, but possibly also as seen along the entire longitudinal extension of the recess, decreases, in particular continuously, along the hopper axis with increasing axial extension. Thus, in a properly mounted state of the charging system, a recess then for example becomes narrower towards a hopper end. It can likewise be provided that all recesses on the hopper wall are each formed to be axially tapering.

When recesses are formed to be both axially and radially tapering, both a width measured in a circumferential direction and a radial depth of a recess decreases towards a hopper end.

In geometrical terms, the hopper wall formed with the recesses can define an inner circumferential line and an outer circumferential line in cross-section. The inner circumferential line touches radially innermost areas of the hopper wall and hence circumscribes a minimum opening cross-section of a hopper opening of the hopper provided for the extruder screw. The outer circumferential line on the other hand touches the radially outermost areas of the recesses. The outer circumferential line hence for example circumscribes a maximum outside diameter of a virtual circular cylinder or a virtual truncated cone, in which the hopper wall with the recesses extends from a first (upper) hopper end to a second (lower) hopper end.

In one design variant it now is provided for example that the hopper opening tapers along the hopper axis so that the minimum opening cross-section decreases along the hopper axis. For example, there can be provided a conical taper of the hopper opening. Thus, the cross-section available for the extruder screw and defined by a diameter of the hopper opening decreases towards a hopper end. A hopper designed in this way can be combined with a conically tapering extruder screw.

In an alternative design variant, in which radially tapering recesses are provided, a diameter of the outer circumferential line on the other hand can decrease along the hopper axis by maintaining the minimum opening cross-section. A diameter of the outer circumferential line thus decreases as seen over the cross-sections along the hopper axis, while the minimum opening cross-section of the hopper opening provided for the extruder screw and hence a diameter of the inner circumferential line remains unchanged along the hopper axis. In this variant, an extruder screw in the extruder apparatus equipped with the charging system then consequently has a constant screw diameter.

In one design variant, two recesses adjoin each other along a circumferential line around the hopper longitudinal axis. Thus, the two recesses directly merge into each other. In particular, all recesses along the circumferential line, which are arranged uniformly distributed around the hopper axis, also can each directly adjoin each other in pairs. Between adjoining recesses, a longitudinally (i.e. along the hopper axis) extending separating edge then is formed, for example. Such a separating edge can then also be formed as a comminuting edge and in particular as a rib on which granular processing material is comminuted, in particular crushed, by action of the extruder screw. Via a separating edge formed correspondingly between two recesses, a shear effect thus can be produced in a targeted way by action of the rotating extruder screw.

Alternatively, a connecting portion can be formed between two recesses along a circumferential line around the hopper axis. Such a connecting portion consequently is not designed as a recess. In particular, a corresponding connecting portion can be shaped differently as compared to the two adjoining recesses. For example, the connecting portion provided between two recesses is designed to be protruding radially inwards, with respect to the hopper axis, and hence in the direction of a hopper opening defined by the hopper for the extruder screw. This in particular includes the fact that as compared to the adjoining recesses, the connecting portion simply protrudes further radially inwards. In particular, the connecting portion can define a flat or curved wall surface.

In the aforementioned case, the connecting portion thus is curved radially inwards, for example with respect to the hopper axis. For example, in a cross-section of the hopper a convexly curved connecting portion is provided between two concavely curved recesses. Here, a steady transition can be provided in a circumferential direction so that between a connecting portion convexly curved radially inwards and a recess concavely curved radially outwards no separating edge is present.

In a cross-section of the hopper on the other hand, a non-curved connecting portion can be formed to extend along a portion of a circular line around the hopper axis and define a flat wall surface. At a transition between such a connecting portion and an adjoining recess, a non-steady or steady transition likewise can be formed, wherein a non-steady transition also includes a formation of a longitudinally extending separating edge. A separating edge between a connecting portion and a recess then can also be formed as a comminuting edge and in particular as a rib and correspondingly can be adapted and provided in particular to comminute at least part of the granular processing material entering the hopper while the extruder screw rotates.

When a plurality of recesses are provided on the hopper wall of the hopper, a flower-shaped cross-section of the hopper can be obtained in one design variant.

The hopper for example can comprise a number nmax of recesses distributed, in particular uniformly distributed over its circumference, for which applies nmax=UD/(a*1.2), wherein nmax is the maximum number of recesses, UD is a circumferential length of the hopper, and a is a mean maximum outer dimension of a granule of a granular processing material to be fed via the charging system. By providing the recesses distributed on the hopper corresponding to the above formula by taking account of the material to be processed, not only as many recesses as possible are formed on the circumference, but the recesses can also easily be designed with dimensions such that granules are retained in the recesses in operation of the extruder apparatus and are blocked against a displacement out of these conveying chambers.

In principle, at least two recesses can be provided on the hopper wall of the proposed charging system. In one design variant, at least four recesses are provided on the hopper wall. For example, the hopper can comprise 4 to 9, in particular, 5 to 7 recesses distributed over the circumference. With more than three recesses or cavities, a flower-shaped cross-section of the hopper can then also be realized, for example.

The proposed solution furthermore comprises an extruder apparatus with at least one extruder screw and at least one design variant of a proposed charging system. In particular, the extruder apparatus can be configured as a 3D printing device or 3D printer. Thus, the proposed extruder apparatus in particular is provided for an additive manufacturing process, in which a component is additively manufactured via the processing material extruded by means of the extruder screw.

### BRIEF DESCRIPTION OF THE DRAWINGS

The attached Figures by way of example illustrate possible design variants of the proposed solution.

FIG. 1 shows a perspective view of an insert for a charging system comprising a first design variant of a hopper flower-shaped in cross-section with a plurality of recesses distributed on the circumference of a hopper wall.

FIG. 2 shows an alternatively designed insert with a hopper likewise flower-shaped in cross-section.

FIG. 3 shows a further design variant of the insert with a differently designed hopper flower-shaped in cross-section.

FIG. 4A shows a cross-sectional view of a hopper.

FIG. 4B shows a perspective representation of the hopper of FIG. 4A or of the hopper opening defined therewith and of an outer shell surface.

FIG. 4C shows a segment of the cross-sectional view of FIG. 4A on an enlarged scale.

FIGS. 5A-5C sectionally and schematically show longitudinal sections through the hopper opening for illustrating different hopper opening geometries.

FIGS. 6A-6C show different cross-sections for design variants of a proposed hopper with and without separating edges between two adjacent and in particular adjoining recesses.

FIG. 7A shows a longitudinal section with an extruder screw arranged in the hopper opening of the hopper.

FIG. 7B in a view corresponding with FIG. 7A shows a differently designed hopper with a conically tapering extruder screw.

FIG. 8 in a perspective view by way of example shows a granule of a thermoplastic material to be processed by means of the proposed solution.

FIG. 9 shows a proposed design variant of a charging system in which an insert as shown in FIGS. 1, 2 and 3 and a hopper as shown in FIGS. 4A to 7B are used.

### DETAILED DESCRIPTION

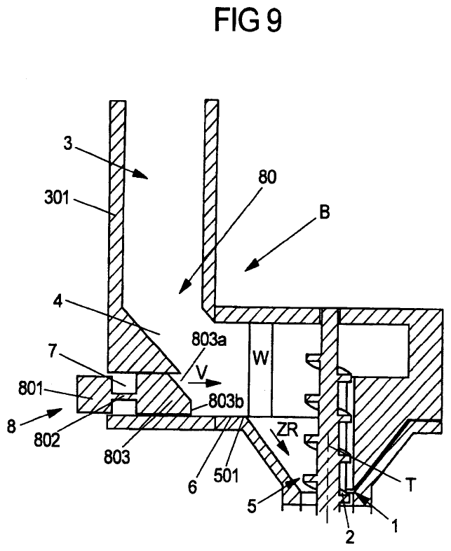

FIG. 9 shows a design variant of a proposed extruder apparatus in the form of a vertical extruder 1. The vertical extruder 1 comprising an extruder screw 2 is shown only in its upper region. The extruder 1 is connected to a charging system B comprising a material reservoir in the form of a bunker 3. At its end facing the extruder screw 2, the bunker 3 is provided with a feed ramp 4 which serves the trouble-free trickling down of granular processing material. The feed ramp 4 is a compact unit which in its upper region is connected to a bunker wall 301.

A (filling) hopper 5 directly rests against the extruder screw 2, wherein the granular processing material is conveyed from the feed ramp 4 into the hopper 5 by action of gravity. Between the feed ramp 4 and the hopper 5, an opening 80 is provided in the bunker wall 301, wherein the feed ramp 4 represents an upper boundary for the opening 80. An upper edge 501 of the hopper 5 merges into a horizontally extending feed zone 6 which in its length extends up to the outer bunker wall 301. This horizontally extending feed zone 6 is the lower boundary for the opening 80.

The opening 80 serves to receive a feeding device 8 and is dimensioned corresponding to the size of the feeding device 8. The feeding device 8 includes a pneumatically, hydraulically, mechanically or electrically driven lifting cylinder 801, a connecting rod 802 and a slide 803. The slide 803 is guided over the horizontally extending feed zone 6 along an adjustment direction V in the direction of a filling zone of the extruder 1. On its side facing the interior of the extruder, the slide 803 has an inclined surface 803a which follows the angle of the feed ramp 4. This surface 803a merges into a ramming surface 803b which is perpendicular and parallel to the bunker wall 301. The ramming surface 803b is at least as large as to correspond to the size of the granulate to be processed.

In the case of small-size screw extruders, the granulate trickling down can be compacted in connection with the granulate pushed back onto the feed ramp 4 and thus forms a wall W of powder that prevents new granulate from being fed to the extruder screw 2. The feeding device 8 prevents the granulate from being pushed back onto the feed ramp 4 on advancement of the slide 803. The stroke of the lifting cylinder 801 is dimensioned such that in the retracted state granulate can perpendicularly fall out of the bunker 3. Based on the retracted state of the lifting cylinder 801, the stroke length of the cylinder 801 corresponds to the distance between the upper edge 501 of the hopper 5 and the vertical ramming surface 803b of the slide 8. The feeding device 8 pierces blockages located in the way of the wall W, and granulate trickling down is actively conveyed into the hopper 5.

Thus, in operation of the extruder 1 the feeding device 8 conveys the processing material recirculated at the hopper 5 by action of the extruder screw 2 against a feed direction ZR together with processing material trickling down from the bunker 3 in the direction of the extruder screw 2. At the hopper 5, processing material recirculated by action of the rotating extruder screw 2 is blended with processing material additionally fed from the bunker 3. This requires a lower compaction of the processing material by the extruder screw 2, and the extruder screw 2 can be designed shorter.

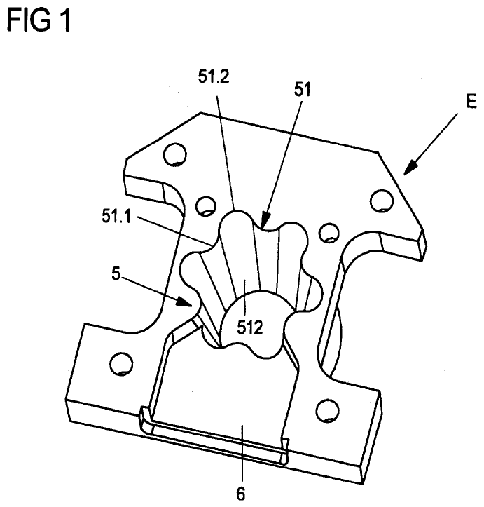

In the charging system B of FIG. 9, the hopper 5 is formed with a plurality of recesses 51.2 on a hopper wall 51. The circumferentially extending hopper wall 51 provided with the recesses 51.2 defines a minimum opening cross-section for a hopper opening through which the extruder screw 2 extends along the hopper axis T from an upper hopper end to a lower hopper end. The hopper 5 here can be formed on a replaceable insert, for which different variants are illustrated in FIGS. 1, 2 and 3 by way of example.

In the insert E of FIG. 1, the hopper wall 51 includes six uniformly distributed, axially extending recesses 51.2 on its circumference. The axially extending recesses 51.2 each are curved radially outwards and thus are formed as recesses of concave cross-section on the hopper wall 51. Each recess 51.2 has a semi-circular cross-sectional area in such a way that a bulge of a recess 51.2 each forms a contour that follows a semi-circular line and extends symmetrically to a straight line extending radially with respect to the hopper axis T. Each recess 51.2 is formed to be radially tapering towards a hopper end 512 of the hopper 5. In the present case, a radial depth of a recess 51.2 decreases continuously with increasing axial extension along the hopper axis T as seen along the longitudinal extension of the respective recess 51.2. Furthermore, a diameter measured in a circumferential direction and hence a width of each recess 51.2 is greater by only a maximum of 20% as compared to a maximum dimension of a granule of the granular processing material to be guided to the extruder screw 2 by means of the charging system B. At the upper end of the hopper 5 a width or a diameter of a recess 51.2 consequently is dimensioned such that a granule can still fall into the respective recess 51.2 from above. At an upper hopper end, an individual granule thus can get into a cavity defined with a recess 51.2. Furthermore, the hopper 5 with its recesses 51.2 is dimensioned in such a way that a granule no longer can easily (i.e. non-destructively and hence without having been comminuted) get out again from a recess 51.2. Thus, the granules are retained in a plurality of defined conveying chambers adjusted to the (mean) dimensions of the granules and are blocked against a displacement out of these conveying chambers, which are each bordered radially on the outside by a recess 51.2 and radially on the inside by the extruder screw 2. In this way, under rotation of the extruder screw 2, an individual granule is forced to perform a downward axial movement along the hopper 5.

To avoid sharp separating and shear edges on the hopper wall 51, a transition between adjacent recesses 51.2 is provided in the design variant of FIG. 1 by radially inwardly convexly curved connecting portions 51.2 In the hopper geometry shown in FIG. 1, recesses 51.2 and connecting portions 51.1 thus steadily merge into each other along a curved circumferential line. The connecting portions 51.1 convexly curved radially inwards are dimensioned in such a way that no granule of the processing material to be processed fits into a resulting gap between a connecting portion 51.1 and an extruder screw 2 rotating into the hopper opening of the hopper 5. A gap between a connecting portion 51.1 and the extruder screw 2 thus is dimensioned so small that no granule fits into this gap.

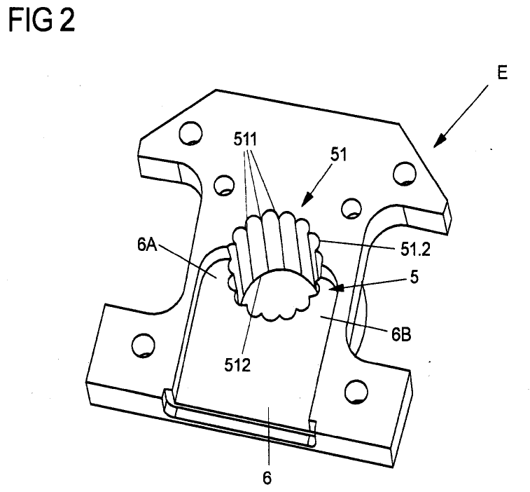

In the design variant of FIG. 2, the insert E with the hopper 5 is designed differently. Here, the recesses 51.2 each directly adjoin each other and are separated from each other in pairs by a separating edge 511 extending along the hopper axis T. This separating edge 511 acts as a comminution edge within the hopper 5 and can be configured as an axially extended sharp-edged rib on which a granulate is crushed by action of the rotating extruder screw 2 and hence is comminuted. Furthermore, in the insert of FIG. 2 the number of recesses 51.2 uniformly distributed on the circumference is distinctly increased with respect to the design variant of FIG. 1. Here, more than fifteen recesses 51.2 are provided.

In addition, the surface area of the feed zone 6 is expanded with respect to the variant of FIG. 1. In the design variant of FIG. 2, the feed zone 6 with its feed edge portions 6A, 6B extends over a larger circumferential area at the upper end of the hopper 5. Analogously to the design variant of FIG. 1, the feed zone 6 of FIG. 2 however is also designed here such that the feed zone 6 (in the top view) laterally each ends in the region of a recess 51.2.

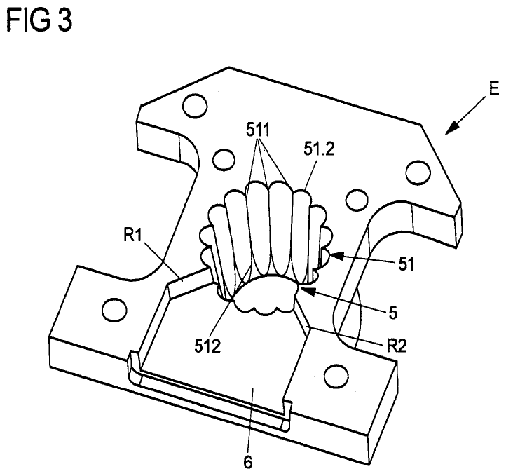

This is also realized in the design variant of FIG. 3. For this purpose, additional inclined ramps R1 and R2 are formed at a lateral edge of the feed zone 6 opening into the hopper 5. The number of recesses 51.2 in the hopper 5 of FIG. 3 is slightly reduced with respect to the design variant of FIG. 2.

In contrast to the design variant of FIGS. 1 and 2, the longitudinally extended recesses 51.2 of the design variant of FIG. 3 additionally are of axially tapering design. Thus, an end portion of each recess 51.2 is pointed in the direction of the lower hopper end 512. However, the recesses 51.2 of the design variant of FIG. 3 furthermore are also formed to be radially tapering so that a radial depth of each recess 51.2 decreases continuously in the direction of the lower hopper end 512.

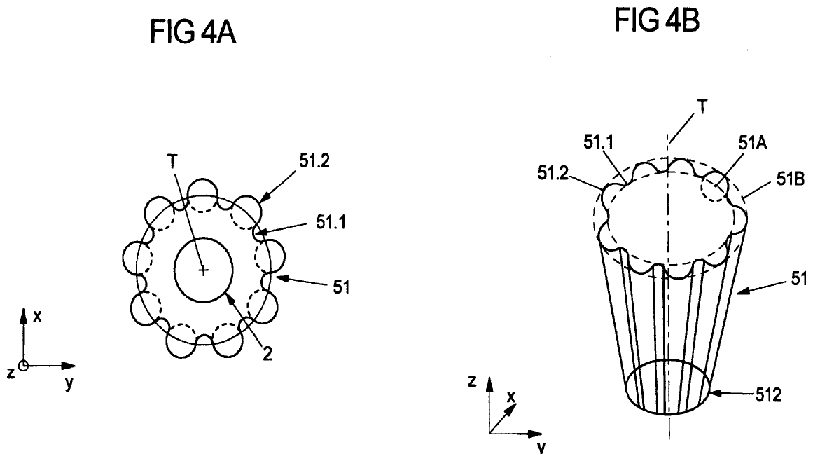

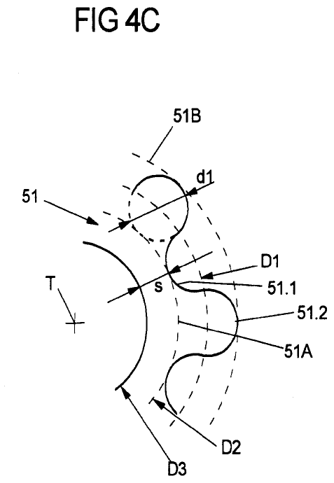

FIGS. 4A, 4B and 4C illustrate geometrical parameters for the design of a hopper 5. FIG. 4A shows a top view of a cross-section through a hopper 5 with recesses 51.2 distributed over the circumference, between each of which convexly curved connecting portions 51.1 extend in the manner of bulges. The recesses 51.2 and connecting portions 51.1 merge into each other on the hopper wall 51 corresponding to a geometrically steady function.

Corresponding to the perspective representation of FIG. 4B, the hopper 5 conically tapers downwards towards the hopper end 512 with respect to an outer circumferential line 51B that touches the radially outermost regions of the recesses 512. Hence, while a diameter of the outer circumferential line 51B decreases continuously along the hopper axis T towards the lower hopper end 512 (due to the radial taper of the individual recesses 51.2), a diameter of an inner circumferential line 51A, which touches the radially innermost regions of the hopper wall 51, remains unchanged however along the hopper axis T. A minimum opening cross-section for the extruder screw 2 thus always remains the same along the hopper axis T.

In FIG. 4C, the diameter of the inner circumferential line 51A is designated with D2. This diameter D2 corresponds to the sum of a diameter D3 of the extruder screw 2 and a defined clearance in the form of a radial distance s between the extruder screw 2 and the circumferential, radially inwardly curved connecting portions 51.1 or the radially inwardly pointing convex bulge of the hopper wall 51 defined therewith in cross-section. This radial distance s, as already explained above, is smaller than a minimum dimension of a granule, which in uncomminuted form thereby fits into a gap between the extruder screw 2 and a bulge 51.1. When a granule G for example has a height H and a diameter D4 corresponding to FIG. 8, it applies: s<D4 and s<H.

In the design variant illustrated with reference to FIG. 4C, the individual recesses 51.2 are designed in cross-section to follow a semi-circular line so that each recess 51.2 defines a semi-circular cross-sectional area. A diameter d1 (varying along the hopper axis T) of the corresponding semi-circle hence defines a radial depth of each recess 51.1. The centers of the individual semi-circles of the recesses 51.1 lie on a circumferential line with the diameter D1 (with D1>D2). The diameter of the outer circumferential line 51B consequently is then given by D1+d1/2. At the upper end of the hopper 5, the diameter d1 is dimensioned such that a granule G corresponding to FIG. 8 can fall into the respective recess 51.2 from above. Here, for example d1≥D4 and d1≥H, respectively, will apply. A maximum number nmax of the recesses 51.1 formed on the hopper 5 and uniformly distributed over the circumference satisfies the restriction nmax=UD/(a*1.2), wherein UD represents a circumferential length of the hopper 5 along the circumferential line 51A and a represents a mean maximum outer dimension of a granule G of a granular processing material to be fed via the charging system. Then, a for example corresponds to the maximum of the two values D4 and H.

An outer shell surface of the hopper wall 51 also tapers with the outer circumferential line 51B. The shell surface hence is obtained as a linear areal interpolation from the arrangement of the recesses 51.1 each semi-circular in cross-section and of the recesses formed therewith including the interposed transitions towards the bulges 51.1 to form a circle that results from the outside diameter D3 of a screw blade of the extruder screw 2.

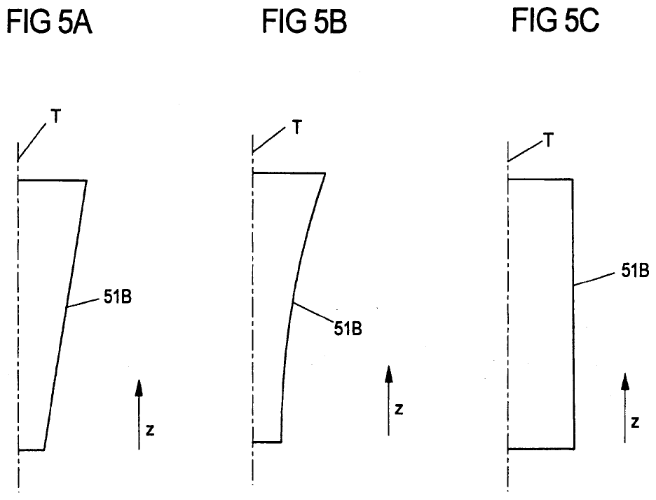

Corresponding to the longitudinal section of FIG. 5A, the outer circumferential line 51B can conically taper in the direction of the lower hopper end 512 along the hopper axis T and thereby along an extension or conveying direction −z. An outer diameter of the hopper 5 thus is designed to decrease linearly and hence to decrease following a first-order function. However, this is not absolutely necessary. For example, a course corresponding to a curve of at least second order also is possible corresponding to FIG. 5B.

A radial taper of the recesses 51.2 was found to be advantageous for example especially with regard to granular processing material made of or comprising comparatively tough thermoplastics. In other processing materials it can also be advantageous, however, when the recesses 51.2 do not taper radially along the hopper axis T. Here, an outer circumferential line 51B then remains unchanged in its diameter in a longitudinal section corresponding to FIG. 5C.

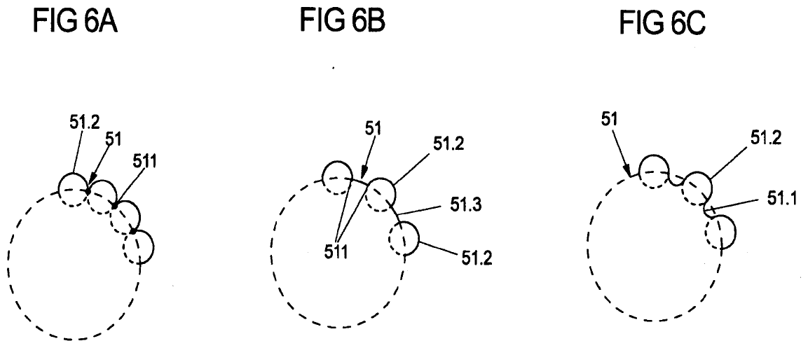

With reference to the cross-sectional views of FIGS. 6A, 6B and 6C different designs of the hopper wall 51 and in particular of the areas between two adjacent recesses 51.2 are illustrated once again.

In the design variant of FIG. 6A, an axially extending separating edge 511 each extends between two recesses 51.2. In the cross-sectional view, the separating edges 511 lie on a circular line with the diameter D2 of FIG. 4C. The separating edges 511 act as a comminuting edge and in particular can be formed as ribs protruding radially in the direction of the extruder screw 2, on which granular processing material is comminuted when the extruder screw 2 rotates around the hopper axis T in operation of the extruder apparatus.

In the design variant of FIG. 6B, connecting portions 51.3 each having a flat wall surface are formed between adjacent recesses 51.2. At the transition from one connecting portion 51.3 to an adjacent recess 51.2 an unsteady transition is provided in the present case, so that a separating edge 511 likewise is each formed between a connecting portion 51.3 and an adjoining recess 51.2.

The variants of FIGS. 6A and 6B with the separating edges 511 are compared with the design variant of FIG. 6C, in which the recesses 51.2 each merge into convexly curved bulges 51.1 and hence connecting portions 51.1 curved radially inwards, steadily and hence free from a separating edge.

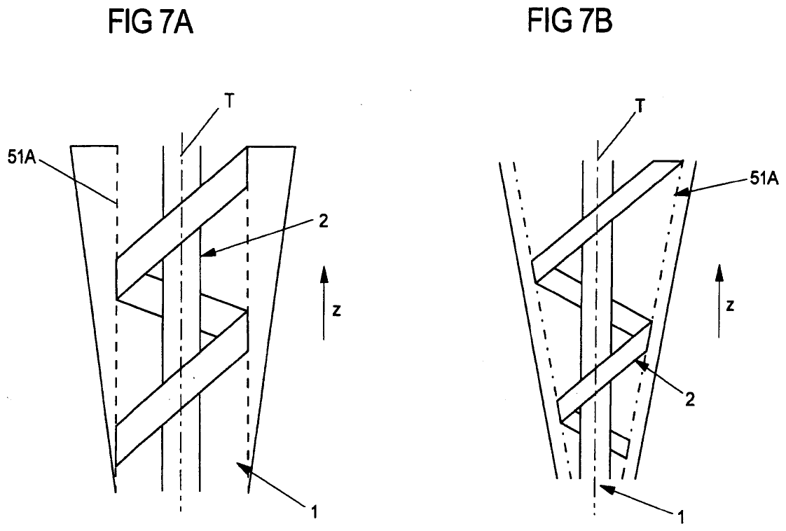

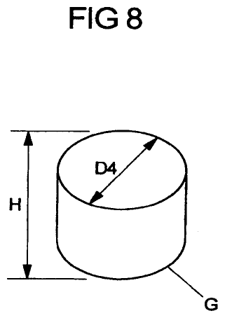

In the case of radially tapering recesses 51.2, as already explained above, a diameter of the inner circumferential line 51A can remain the same along the hopper axis T. In the longitudinal section corresponding to FIG. 7A, a diameter D3 of the extruder screw 2 thus also always remains unchanged. On the other hand, however, a design variant in which a diameter D3 is reduced continuously along the hopper axis T also is possible. Thus, the hopper opening conically tapers in the z-direction. Correspondingly, in the longitudinal section of FIG. 7B, the extruder screw 2 then also has a conical course.

In all design variants, the incoming granular material G easily falls into the hopper 5 and is moved on by the extruder screw 2. The hopper (inner) wall 51 in the hopper 5 formed with recesses 51.2 on the one hand prevents that the supplied processing material at the edge of the extruder screw 2 only moves in a circumferential direction, i.e. only with the rotation of the extruder screw 2, and is not conveyed downwards. As soon as grains of the granular processing material present at the edge of the extruder screw 2 impinge on the hopper wall 51, the blocking of the movement in a circumferential direction causes a movement in an axial direction. Due to the simultaneously very small space between the screw shaft and the screw blade of the extruder screw 2, the processing material cannot be moved on as a whole and is possibly additionally comminuted at separating edges 511 on the hopper inner wall 51 and moved downwards axially along the hopper axis T. The hardness of the screw shaft of the extruder screw 2 and the hopper wall 51 typically is greater than the hardness of the processing material to be processed.

It could be observed that by using the proposed hopper 5 without any thermal influence an improved compaction and homogenization of the processing material to be conveyed is obtained, which is distinctly improved as compared to conventional hopper solutions, in particular when comparatively tough thermoplastic materials are supplied. As compared to conventional hopper solutions, verifiably more uniform extrusion patterns can be realized. The compression zone and a discharge zone succeeding along a longitudinal hopper axis T furthermore can be of distinctly shortened design so that the extruder 1 remains very compact and a length-diameter ratio of 1:10 to 1:3 can be achieved.

### LIST OF REFERENCE NUMERALS

1 extruder
2 extruder screw
3 bunker (material reservoir)
301 bunker wall
4 feed ramp
5 hopper
501 upper edge of hopper
51 hopper wall
51.1 bulge (curved connecting portion)
51.2 recess
51.3 planar/flat connecting portion
511 comminuting/separating edge
512 hopper end
51A inner circumferential line
51B outer circumferential line/shell surface
6 horizontally extending feed zone
6A, 6B feed edge portion
7 opening
8 feeding device
80 opening
801 lifting cylinder
802 connecting rod
803 slide
803a inclined surface
803b ramming surface
B charging system
D₁-D₄, d₁ diameter
E insert
G granulate (processing material)
H height
R1, R2 lateral ramp
s distance
T hopper axis
V adjustment direction
W wall
ZR feed direction
−z direction of longitudinal extension/conveying direction

1. A charging system for feeding processing material to at least one extruder screw, the charging system comprising:
a hopper that is adapted to guide the processing material along a feed direction to the extruder screw and that extends along a hopper axis, which in a properly mounted state of the charging system extends parallel to a longitudinal axis of the extruder screw,
wherein on a hopper wall extending around the hopper axis, the hopper includes a plurality of recesses, each recess extending axially with respect to the hopper axis.

2. The charging system according to claim 1, wherein the recesses are arranged in succession along a circumferential line around the hopper axis.

3. The charging system according to claim 1, wherein in cross-section the recesses are radially curved towards the outside, with respect to the hopper axis.

4. The charging system according to claim 1, wherein at least one of the recesses is formed to be radially tapering.

5. The charging system according to claim 4, wherein all recesses are each formed to be radially tapering.

6. The charging system according to claim 1, wherein at least one of the recesses is formed to be axially tapering.

7. The charging system according to claim 6, wherein all recesses are each formed to be axially tapering.

8. The charging system according to claim 1, wherein in cross-section the hopper wall formed with the recesses defines an inner circumferential line and an outer circumferential line, wherein the inner circumferential line touches radially innermost areas of the hopper wall and circumscribes a minimum opening cross-section of a hopper opening of the hopper-provided for the extruder screw, and wherein the outer circumferential line touches the radially outermost areas of the recesses.

9. The charging system according to claim 8, wherein the hopper opening tapers along the hopper axis so that the minimum opening cross-section decreases along the hopper axis.

10. (canceled)

11. The charging system according to claim 1, wherein two recesses adjoin each other along a circumferential line around the hopper axis.

12. The charging system according to claim 11, wherein between two adjoining recesses a longitudinally extending separating edge is formed.

13. The charging system according to claim 11, wherein all recesses adjoin each other in pairs along the circumferential line around the hopper axis.

14. The charging system according to claim 1, wherein a connecting portion is formed between two recesses-along a circumferential line around the hopper axis.

15. The charging system according to claim 14, wherein the connecting portion is curved radially inwards, with respect to the hopper axis, or in cross-section the connecting portion extends along a portion of a circular line around the hopper axis and defines a flat wall surface.

16. (canceled)

17. (canceled)

18. The charging system according to claim 12, wherein the separating edge is adapted and provided such that at the separating edge at least part of granular processing material entering the hopper is comminuted while the extruder screw rotates.

19. The charging system according to claim 1, wherein the hopper with the recesses has a flower-shaped cross-section.

20. The charging system according to claim 1, wherein the hopper comprises a number nₘₐₓ of recesses distributed over the circumference, for which applies nₘₐₓ=U_{D}/(a*1.2), wherein nₘₐₓ is the maximum number of recesses, U_{D} is a circumferential length of the hopper, and a is a mean maximum outer dimension of a granule of a granular processing material to be fed via the charging system.

21. The charging system according to claim 1, wherein the hopper comprises 4 to recesses distributed over the circumference.

22. An extruder apparatus, comprising at least one extruder screw and at least one charging system according to claim 1.

23. A 3D printing device comprising at least one charging system according to claim 1.
